(19) United States
(12) Patent Application Publication
(10) Pub. No.: US 2025/0356614 A1
(43) Pub. Date: Nov. 20, 2025

(54) ALIGNED VISION-LANGUAGE MODEL FOR TEXT-RICH IMAGE UNDERSTANDING

(71) Applicant: Adobe Inc., San Jose, CA (US)

(72) Inventors: Ruiyi Zhang, San Jose, CA (US); Jiuxiang Gu, College Park, MD (US); Yufan Zhou, Buffalo, NY (US); Nedim Lipka, Santa Clara, CA (US); Yanzhe Zhang, Palo Alto, CA (US); Tong Sun, San Jose, CA (US)

(21) Appl. No.: 18/666,519

(22) Filed: May 16, 2024

(51) Int. Cl. G06V 10/44; G06T 3/40; G06V 10/762; G06V 10/764; G06V 30/10

(52) U.S. Cl. CPC G06V 10/44; G06T 3/40; G06V 10/762; G06V 10/764; G06V 30/10

(57) ABSTRACT

The present disclosure relates to systems, non-transitory computer-readable media, and methods for generating and implementing a vision-language model that identifies and understands text-rich content depicted in digital images. For example, the disclosed systems determine, from among a plurality of digital images with at least a threshold probability of depicting text-rich content, a subset of digital images corresponding to a set of text-rich image classifications. In some embodiments, the disclosed systems generate a ground truth text phrase utilizing an optical character recognition model to process a digital image from the subset of digital images. In certain embodiments, the disclosed systems also generate a predicted text phrase utilizing a vision-language model and compare the ground truth text phrase with the predicted text phrase. In some embodiments, the disclosed systems modify parameters of the vision-language model based on comparing the ground truth text phrase and the predicted text phrase.

### BACKGROUND

Recent years have seen significant developments in systems that generate responses to prompts in conversations with large language models. For example, some recently developed systems utilize specialized adaptations to large language models, called vision-language models, that implement vision assistants to generate and analyze digital images. Some existing vision-language models generate digital images from text prompts and/or generate descriptions of image content depicted by digital images in response to requests from text prompts. Although conventional systems are able to generate images and/or generate image descriptions, these systems exhibit a number of technical deficiencies, especially regarding understanding of text-rich content depicted in digital images.

### SUMMARY

Embodiments of the present disclosure provide benefits and/or solve one or more of the foregoing or other problems in the art with systems, non-transitory computer-readable media, and methods for generating and implementing a vision-language model that identifies and understands text-rich content depicted in digital images. For example, the disclosed systems generate a vision-language model utilizing a training process for updating model parameters based on unique data, including digital images clustered into text-rich image classifications of images with at least a threshold probability of depicting text-rich content, and further including ground truth indications of text depicted in digital images. In some embodiments, the vision-language model has a unique architecture that includes a high-resolution vision encoder, a low-resolution vision encoder, a projection matrix, and a language decoder. In one or more embodiments, updating parameters of the vision-language model involves two stages, a pretraining stage and a finetuning stage, where different architectural components are frozen at each stage for targeted updating of model parameters at different levels of the architecture (and based on different data). Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an example system environment in which a text understanding system operates in accordance with one or more embodiments.

FIG. 2 illustrates an overview of training a vision-language model using a pretraining dataset and a finetuning dataset for generating text phrases from text-rich digital images in accordance with one or more embodiments.

FIG. 3 illustrates an example diagram for generating a pretraining dataset in accordance with one or more embodiments.

FIG. 4 illustrates an example diagram for generating a finetuning dataset in accordance with one or more embodiments.

FIG. 5 illustrates an example diagram for a two-stage training process in accordance with one or more embodiments.

FIG. 6 illustrates an example diagram for utilizing a vision-language model with a dual-vision-encoder architecture to generate a text phrase from a digital image in accordance with one or more embodiments.

FIG. 7 illustrates an example table of experimental results in accordance with one or more embodiments.

FIG. 8 illustrates an example table of experimental results in accordance with one or more embodiments.

FIG. 9 illustrates an example comparison of generated text phrases comparing performance of different models on a sample digital image in accordance with one or more embodiments.

FIG. 10 illustrates an example comparison of models in generating responses to a series of text phrase prompts about a digital image in accordance with one or more embodiments.

FIG. 11 illustrates a schematic diagram of a text understanding system in accordance with one or more embodiments.

FIG. 12 illustrates a flowchart of a series of acts for training a vision-language model using text-rich digital images and ground truth text phrases in accordance with one or more embodiments.

FIG. 13 illustrates a flowchart of a series of acts for training a vision-language model using a pretraining dataset and a finetuning dataset in accordance with one or more embodiments.

FIG. 14 illustrates a flowchart of a series of acts for utilizing a vision-language model with a dual-vision-encoder architecture to generate a text phrase from a digital image in accordance with one or more embodiments.

FIG. 15 illustrates a block diagram of an example computing device for implementing one or more embodiments of the present disclosure.

### DETAILED DESCRIPTION

This disclosure describes one or more embodiments of a text understanding system that trains the utilizes a vision-language model to detect and understand text-rich content depicted in digital images. For example, the text understanding system utilizes a vision-language model with a unique architecture and updates parameters of the vision-language model using unique training data for a two-stage training process that includes pretraining and finetuning. In some embodiments, the text understanding system generates the unique training data by generating a pretraining dataset for the pretraining stage and a finetuning dataset for the finetuning stage, where each dataset includes images depicting text-rich content. In certain cases, the text understanding system thus modifies parameters of a vision-language model to detect text-rich content based on pretraining data and finetuning data that include text-rich digital images and ground truth text phrases of text content depicted in the digital images.

As just mentioned, in some embodiments, the text understanding system generates a pretraining dataset for a pretraining stage of a vision-language model. For example, the text understanding system determines or identifies (e.g., using an image text detection model) digital images with at least a threshold probability of depicting text-rich content. In some cases, the text understanding system further clusters the text-rich images into image classifications and selects images from a subset of image classifications corresponding to text-rich content (e.g., text-rich image classifications that indicate text content in the images). Additionally, in certain embodiments, the text understanding system utilizes an optical character recognition model to process text-rich images from the selected clusters to generate ground truth text phrases of the text content shown in the images.

In addition, in some embodiments, the text understanding system generates a finetuning dataset for a finetuning stage of a vision-language model. For example, the text understanding system selects one or more images from the pretraining dataset (and the corresponding ground truth text phrases) to pair with sample text phrase prompts. In some embodiments, the text understanding system generates sample text phrase prompts by generating a set of text prompt variations from an initial text phrase prompt. Additionally, in some cases, the text understanding system selects a text phrase prompt to pair with a text-rich image (and its corresponding ground truth text phrase) from among the text phrase prompt variations.

As indicated above, in certain embodiments, the text understanding system trains a vision-language model with a unique architecture. For example, the vision-language model includes a high-resolution vision encoder and a low-level vision encoder. Indeed, in some cases, the high-resolution vision encoder extracts image features at a resolution higher than that of the low-resolution vision encoder. Consequently, in some embodiments, the vision-language model includes a cross-attention layer that transforms or converts the high-resolution visual features of the high-resolution vision encoder into key-value pairs that are compatible with other components of the vision-language model (e.g., to align with an embedding space of the language decoder). In addition, in one or more embodiments, the vision-language model includes a projection matrix and a language decoder, where the projection matrix projects low-resolution visual features of the low-resolution vision encoder into the embedding space of the language decoder.

As also mentioned, in some embodiments, the text understanding system trains a vision-language model using a two-stage training process. For instance, the text understanding system utilizes a pretraining stage to modify parameters by comparing predicted text phrases from text-rich digital images with ground truth text phrases included in the pretraining dataset. In addition, in some embodiments, the text understanding system utilizes a finetuning stage to modify parameters by comparing predicted text phrases with ground truth text phrases generated from digital images and their corresponding text phrase prompts. In some cases, the text understanding system freezes different components of the vision-language model at the different training stages. For example, the text understanding system freezes the language decoder and the vision encoders during pretraining (modifying only parameters of the projection matrix) and freezes the vision encoders during finetuning (modifying parameters of the projection matrix and the language decoder).

In addition to training a vision-language model, in some embodiments, the text understanding system utilizes or implements a vision-language model trained as described herein. For example, the text understanding system receives a digital image (e.g., as an upload or a selection) along with a text phrase prompt from a client device. In response, the text understanding system utilizes a vision-language model (trained as described herein) to generate a text phrase from text-rich content depicted in a digital image. For instance, the vision-language model processes the input digital image and the input text phrase prompt to generate a text phrase, such as text depicted in an image of a billboard, an image of a logo t-shirt, an image of a restaurant menu, or some other text-rich digital image.

As suggested above, many conventional systems exhibit a number of shortcomings or disadvantages, particularly in their understanding of text-rich image content. To elaborate, many existing systems generate or extract inaccurate text phrases from digital images depicting text-rich content, such as billboard, logos, menus, or other text-rich image content. Indeed, due to their limitations in training data and in network architecture, models implemented by existing systems struggle to comprehend and understand text from images. For example, many existing systems use large language models tuned to generate responses from text prompts, including descriptions of image content shown in an image. But the architecture and parameters of such systems are poorly equipped to analyze and extract text shown in digital images, often producing nonsensical (or otherwise incorrect) phrases when tasked with identifying text shown in an image.

Contributing to their inaccuracies, some prior systems use models with a single vision encoder. In many cases, the single vision encoder of existing systems supports relatively low resolutions (e.g., up to 336² pixels), which is often too low to accurately extract visual features from text characters depicted in a digital image. Indeed, text content is often too small to be captured by low-resolution vision encoders alone, and existing systems therefore frequently generate inaccurate text phrases from digital images that either incorrectly predict depicted text or miss the depicted text entirely.

As suggested above, embodiments of the text understanding system provide certain improvements or advantages over conventional systems. For example, embodiments of the text understanding system improve accuracy in extracting and understanding text content depicted in digital images. Embodiments of the text understanding system exhibit such accuracy improvements due to generating improved datasets, training model parameters using a specialized two-stage training process, and/or using a vision-language model with a unique dual-vision-encoder architecture.

For example, in some embodiments, the text understanding system generates a pretraining dataset and a finetuning dataset, where each dataset includes images with at least a threshold probability of depicting text-rich content as well as corresponding ground-truth text phrases for text in the images. Indeed, the text understanding system generates training data using an optical character recognition model to generate ground truth text phrases from digital images. In addition, the text understanding system refines training data by selecting digital images that satisfy a threshold probability of depicting text-rich content and that are clustered into text-rich image classifications. Using its improved training data, the text understanding system trains vision-language models to generate text phrases from text-rich content of digital images more accurately than prior systems.

As part of improving the accuracy of a vision-language model, embodiments of the text understanding system utilize the improved training datasets as part of a two-stage training process. For example, the text understanding system uses a pretraining dataset and a finetuning dataset in respective training stages, including a pretraining stage and a finetuning stage for modifying parameters of a vision-language model. During the pretraining stage, the text understanding system freezes a language decoder and the dual vision encoders to only modify parameters of a projection matrix (and a cross-attention layer). During the finetuning stage, the text understanding system freezes the dual vision encoders to modify parameters of the language decoder and the projection matrix (and the cross-attention layer). Using the two-stage training process by freezing different components at different stages, the text understanding system improves the parameters modification process, resulting in a vision-language model that generates more accurate text phrases from text-rich content.

Further contributing to accuracy improvements, embodiments of the text understanding system utilize a dual-vision-encoder architecture. Indeed, the text understanding system trains and implements a vision-language model including a high-resolution vision encoder and a low-resolution vision encoder. Using a dual-vision-encoder architecture, the text understanding system extracts visual features in multiple resolutions to capture depicted text content more accurately than prior systems. As explained in further detail below, experimenters have demonstrated accuracy improvements of various embodiments of the text understanding system exhibiting up to 20% improvement over existing systems when extracting text phrases.

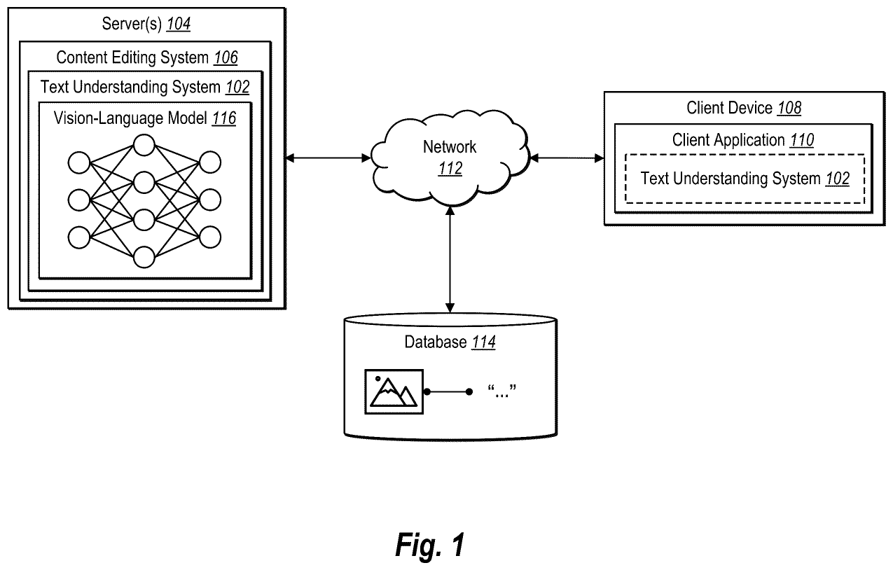

Additional detail regarding the text understanding system will now be provided with reference to the figures. For example, FIG. 1 illustrates a schematic diagram of an example system environment for implementing a text understanding system 102 in accordance with one or more embodiments. An overview of the text understanding system 102 is described in relation to FIG. 1. Thereafter, a more detailed description of the components and processes of the text understanding system 102 is provided in relation to the subsequent figures.

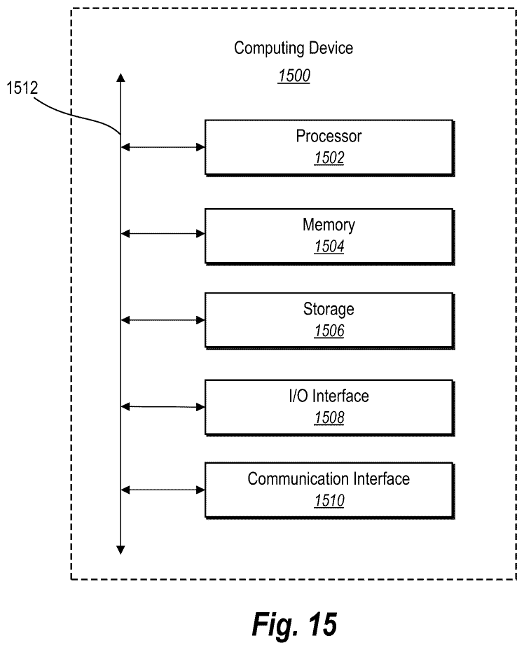

As shown, the environment includes server(s) 104, a client device 108, a database 114, and a network 112. Each of the components of the environment communicate via the network 112, and the network 112 is any suitable network over which computing devices communicate. Example networks are discussed in more detail below in relation to FIG. 15.

As mentioned, the environment includes a client device 108. The client device 108 is one of a variety of computing devices, including a smartphone, a tablet, a smart television, a desktop computer, a laptop computer, a virtual reality device, an augmented reality device, or another computing device as described in relation to FIG. 15. Although FIG. 1 illustrates a single instance of the client device 108, in some embodiments, the environment includes multiple different client devices, each associated with a different user. The client device 108 communicates with the server(s) 104 and/or the content editing system 106 via network 112. For example, the client device 108 receives text phrase prompts and/or digital images and provides information to server(s) 104 indicating the text phrase prompts and the digital images for determining textual content.

As shown in FIG. 1, the client device 108 includes a client application 110. In particular, the client application 110 is a web application, a native application installed on the client device 108 (e.g., a mobile application or a desktop application), or a cloud-based application where all or part of the functionality is performed by the server(s) 104. The client application 110 presents or displays information to a user, including a vision-language interface for using a vision-language model 116 to generate text phrases from digital images (e.g., in a conversation of prompt-and-response in a chat-like interface).

As also illustrated in FIG. 1, the environment includes the server(s) 104. The server(s) 104 generates, tracks, stores, processes, receives, and transmits electronic data, such as text phrase prompts, digital images, extracted embeddings, and/or text phrases. For example, the server(s) 104 receives data from the client device 108 in the form of a text phrase prompt and/or a text-rich digital image. In response, the server(s) 104 provides data to the client device 108 in the form of a trained model (e.g., the vision-language model 116) or an output generated by a trained model that is trained according to datasets as described herein. For example, the server(s) 104 communicate with the database 114 to generate one or more datasets of digital images and corresponding ground truth text phrases for training the vision-language model 116.

In some embodiments, the server(s) 104 communicates with the client device 108 to transmit and/or receive data via the network 112. In some embodiments, the server(s) 104 comprises a distributed server where the server(s) 104 includes a number of server devices distributed across the network 112 and located in different physical locations. The server(s) 104 comprise a content server, an application server, a communication server, a web-hosting server, a multidimensional server, or a machine learning server.

As further shown in FIG. 1, the server(s) 104 also includes the text understanding system 102 as part of a content editing system 106. For example, in one or more implementations, the content editing system 106 stores, generates, modifies, edits, enhances, provides, distributes, and/or shares digital content, such as digital images generated text phrases. For example, the content editing system 106 provides digital content for editing or other forms of digital processing. In some implementations, the content editing system 106 provides digital content to particular digital profiles associated with client devices (e.g., the client device 108).

In one or more embodiments, the server(s) 104 includes all, or a portion of, the text understanding system 102. For example, the text understanding system 102 operates on the server(s) 104 to generate or modify one or more datasets, such as a pretraining dataset and a finetuning dataset. In some embodiments, the client device 108 includes all or part of the text understanding system 102. For example, the client device 108 generates, obtains (e.g., downloads), or uses one or more aspects of the text understanding system 102, such as the vision-language model 116. Indeed, in some implementations, as illustrated in FIG. 1, the text understanding system 102 is located in whole or in part of the client device 108 (e.g., as part of the client application 110). For example, the text understanding system 102 includes a web hosting application that allows the client device 108 to interact with the server(s) 104. To illustrate, in one or more implementations, the client device 108 accesses a web page supported and/or hosted by the server(s) 104.

In one or more embodiments, the client device 108 and the server(s) 104 work together to implement the text understanding system 102. For example, in some embodiments, the server(s) 104 train one or more neural networks (e.g., the vision-language model 116, optical character recognition models, and/or image text detection models) and provide the one or more neural networks to the client device 108 for implementation. In some embodiments, the server(s) 104 trains one or more neural networks together with the client device 108.

Although FIG. 1 illustrates a particular arrangement of the environment, in some embodiments, the environment has a different arrangement of components and/or may have a different number or set of components altogether. For instance, as mentioned, the text understanding system 102 is implemented by (e.g., located entirely or in part on) the client device 108. In addition, in one or more embodiments, the client device 108 communicates directly with the text understanding system 102, bypassing the network 112.

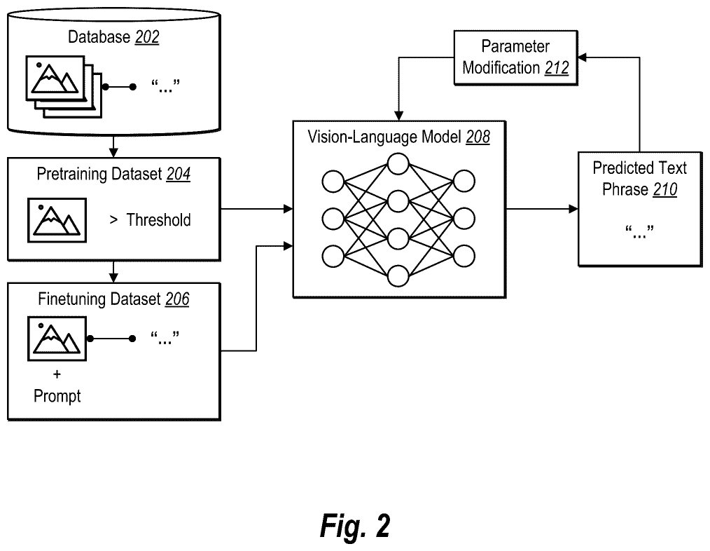

As mentioned, in one or more embodiments, the text understanding system 102 trains a vision-language model to generate text phrases from text-rich digital images. In particular, the text understanding system 102 utilizes a pretraining dataset and a finetuning dataset to train a vision-language model to recognize and extract text depicted by pixels of a digital image. FIG. 2 illustrates an example overview of in accordance with one or more embodiments. Additional detail regarding the various acts and processes introduced in relation to FIG. 2 is provided thereafter with reference to subsequent figures.

As illustrated in FIG. 2, the text understanding system 102 accesses a database 202 (e.g., the database 114) to retrieve or obtain training data. For example, the database 202 stores a variety of digital images with pixels depicting a range of image content, some including text-rich content and others not. In some embodiments, text-rich content includes image content portrayed or depicted by pixels of a digital image as reflecting one or more text characters. In certain embodiments, text-rich content does not include digital text (e.g., typewritten font glyphs) included as part of a digital image but instead includes image content with pixels arranged to depict text characters within the image pixels. In some cases, the database 202 stores data from the LAION-5B dataset described by Christoph Schuhmann et al. in LAION-5B: An Open Large-Scale Dataset for Training Next Generation Image-Text Models, arXiv: 2210.08402 (2022).

From the database 202, as shown in FIG. 2, the text understanding system 102 generates a pretraining dataset 204. To elaborate, the text understanding system 102 utilizes an image text detection model to process digital images in the database 202. The image text detection model generates a probability that a digital image depicts text-rich content. In some cases, an image text detection model includes or refers to a model with an architecture that analyzes pixels of digital images to generate probabilities of the images depicted (at least a threshold amount of) text content. In some embodiments, the text understanding system 102 trains or finetunes an image text detection model using a dataset including image-text pairs for document image classification and retrieval. Using such a model, the text understanding system 102 thus identifies, from the database 202, digital images with at least a threshold probability of depicting text-rich content. Indeed, the text understanding system 102 compares the probabilities generated by the image text detection model with a probability threshold (e.g., 0.8 or 80%) and selects those that satisfy the threshold, discarding or filtering out the others.

To generate the pretraining dataset 204, the text understanding system 102 further samples or selects digital images from the subset of text-rich images (e.g., those images that satisfy the probability of depicting text-rich content). More particularly, the text understanding system 102 clusters the text-rich images into clusters defining image classifications. The text understanding system 102 further selects a subset of the total clusters, where each cluster in the subset defines a text-rich image classification. For instance, a text-right image classification includes or refers to an image classification or a cluster that corresponds to a particular text-related label. In some cases, a text-rich image classification includes images depicting text-rich content, such as billboard images, logo images, menu images, advertisement images, poster images, educational material images, infographics images and other text-related images.

In some embodiments, as part of generating the pretraining dataset 204, the text understanding system 102 further generates ground truth text phrases. For example, a ground truth text phrase includes or refers to a text phrase extracted from a digital image used to train parameters of a vision-language model as a target for predicting a text phrase from the digital image. In some cases, a ground truth text phrase represents actual text depicted in a digital image and/or text extracted using an optical character recognition model. The text understanding system 102 thus generates a ground truth text phrase by using an optical character recognition model to process a digital image to detect or recognize text characters or glyphs depicted in the image. In some embodiments, the text understanding system 102 utilizes the optical character recognition model that scans or processes pixels of a digital image to extract text glyphs and combine them into words, phrases, or sentences. For instance, the text understanding system 102 utilizes an open-source optical character recognition model, such as PaddleOCR.

As further illustrated in FIG. 2, the text understanding system 102 generates a finetuning dataset 206. More specifically, the text understanding system 102 generates the finetuning dataset by selecting one or more text-rich images from the pretraining dataset 204 to pair with text phrase prompts. In some embodiments, a text phrase prompt includes or refers to a string of text characters processable by a vision-language model (together with a digital image) to generate a predicted text phrase of characters or glyphs (depicted in the digital image). To determine a text phrase prompt, the text understanding system 102 (randomly) samples or selects a text phrase prompt from among a set of candidate text phrase prompts to pair with a text-rich image. In some case, the text understanding system 102 generates or identifies the set of candidate text phrase prompts as variations of an example text phrase prompt. The text understanding system 102 thus selects a text phrase prompt variation to pair with a text-rich digital image within the finetuning dataset 206 as input data corresponding to a ground truth text phrase (as determined via optical character recognition).

As also illustrated in FIG. 2, the text understanding system 102 trains a vision-language model 208 using the pretraining dataset 204 and the finetuning dataset 206. For instance, the text understanding system 102 trains the vision-language model 208 to generate predicted text phrases that match or align with ground truth text phrases included in the pretraining dataset 204 and/or the finetuning dataset 206. In some embodiments, a vision-language model includes or refers to a neural network that processes digital images and/or text prompts to generate text phrases (e.g., text phrases indicating glyphs or words shown in text-rich content of the images). For example, a vision-language model includes or refers to a model based on the architecture described by Simon Jenni et al. in U.S. patent application Ser. No. 18/443,808, titled BUILDING VISION-LANGUAGE MODELS USING MASKED DISTILLATION FROM FOUNDATION MODELS, filed Feb. 16, 2024, which is hereby incorporated by reference in its entirety. In some cases, a vision-language model has a particular neural network architecture, including a high-resolution vision encoder, a low-resolution vision encoder, a language decoder, a projection matrix, and a cross-attention layer. In some embodiments, the language decoder of the vision-language model is a large language model that processes input embeddings (from visual features and prompt features) to generate output text phrases.

In some embodiments, a neural network (e.g., a vision-language model, an image text detection model, and/or an optical character recognition model) includes or refers to a machine learning model that is trainable and/or tunable based on inputs to generate predictions, determine classifications, or approximate unknown functions. For example, a neural network includes a model of interconnected artificial neurons (e.g., organized in layers) that communicate and learn to approximate complex functions and generate outputs (e.g., digital images and/or digital text) based on a plurality of inputs provided to the neural network. In some cases, a neural network refers to an algorithm (or set of algorithms) that implements deep learning techniques to model high-level abstractions in data. For example, a neural network includes a deep neural network, a convolutional neural network, a recurrent neural network (e.g., an LSTM), a graph neural network, a transformer, or a generative neural network (e.g., a generative adversarial neural network or a diffusion neural network).

As part of training the vision-language model 208, the text understanding system 102 provides input data to the vision-language model 208, whereupon the vision-language model 208 generates a predicted text phrase 210. Indeed, the vision-language model 208 generates the predicted text phrase 210 as a prediction of text characters shown in pixels of an input digital image. From the predicted text phrase 210, the text understanding system 102 performs a parameter modification 212 to modify, update, or adjust parameters of (various components of) the vision-language model 208. For example, the text understanding system 102 updates parameters according to a loss function to reduce a measure of loss and improve model accuracy in predicting text phrases. As part of the loss function, the text understanding system 102 compares the predicted text phrase 210 with a ground truth text phrase to determine the measure of loss.

In some embodiments, the parameter modification 212 includes modifying parameters during a pretraining stage and/or during a finetuning stage. For pretraining, the text understanding system 102 inputs data from the pretraining dataset 204, including a sample digital image and a corresponding ground truth text phrase, whereupon the vision-language model 208 generates a predicted text phrase. The text understanding system 102 further freezes the language decoder and the vision tower (including the high-resolution vision encoder and the low-resolution vision encoder) of the vision-language model 208 during pretraining to modify only parameters of the projection matrix as part of the parameter modification 212 (e.g., based on comparing to a ground truth text phrase from the pretraining dataset 204).

For finetuning, the text understanding system 102 inputs data from the finetuning dataset 206. Specifically, the text understanding system 102 inputs a digital image and a sample text prompt variation into the vision-language model 208, whereupon the vision-language model 208 generates a predicted text phrase. The text understanding system 102 further freezes the vision tower (including the high-resolution vision encoder and the low-resolution vision encoder) of the vision-language model 208 during finetuning, only modifying parameters of the language decoder and the projection matrix as part of the parameter modification 212 (e.g., based on comparing to a ground truth text phrase from the finetuning dataset 206).

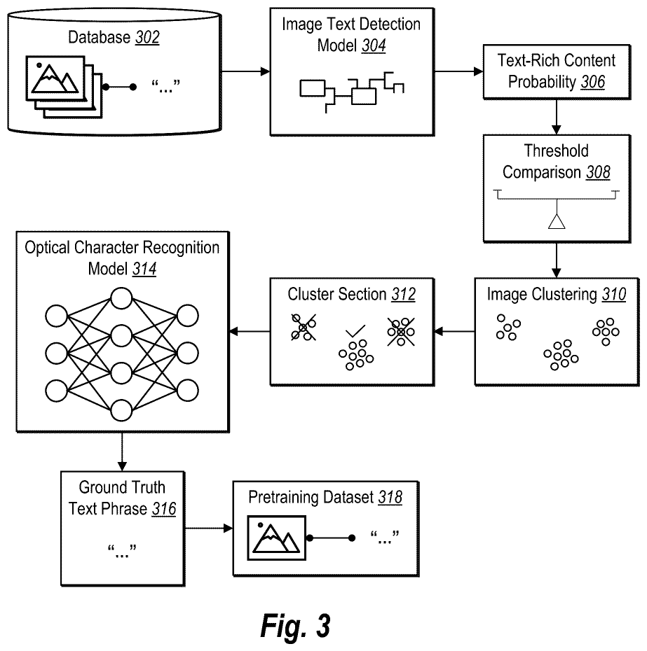

As mentioned above, in certain described embodiments, the text understanding system 102 generates a pretraining dataset for modifying parameters of a vision-language model. In particular, the text understanding system 102 generates a pretraining dataset for modifying parameters to improve accuracy and capability in extracting and generating text phrases from text-rich digital images. FIG. 3 illustrates an example process for generating a pretraining dataset in accordance with one or more embodiments.

As illustrated in FIG. 3, the text understanding system 102 accesses a database 302 (e.g., the database 114). In particular, the text understanding system 102 accesses the database 302 storing or housing a plurality of digital images, such as those in the LAION-5B dataset. From the database 302, the text understanding system 102 selects a subset of digital images to include in a pretraining dataset. For instance, the text understanding system 102 utilizes an image text detection model 304 to analyze a digital image from the database 302 to determine a text-rich content probability 306. Indeed, the image text detection model 304 generates the text-rich content probability 306 indicating a probability or a likelihood that (at least a threshold area or amount of) pixels of the digital image depict text glyphs or characters.

As further illustrated in FIG. 3, the text understanding system 102 performs a threshold comparison 308. For instance, the text understanding system 102 compares the text-rich content probability 306 with a threshold probability of depicting text-rich content. In some cases, the text understanding system 102 utilizes a threshold probability of 0.8 or 80%, selecting images satisfying the threshold as text-rich images. Indeed, the text understanding system 102 selects text-rich images as images satisfying the text-rich content probability threshold.

In some embodiments, as part of the threshold comparison 308, the text understanding system 102 also determines and selects digital images that satisfy a watermark probability threshold. For instance, the text understanding system 102 utilizes a watermark probability model (e.g., a neural network) to determine a probability that the digital image includes or depicts a watermark. The text understanding system 102 further compares the watermark probability with a watermark probability threshold (p(watermark)<0.8) to determine whether to select or filter out the image.

In certain embodiments, as part of the threshold comparison 308, the text understanding system 102 further determines and selects digital images that satisfy a safety probability threshold. For instance, the text understanding system 102 utilizes a safety probability model (e.g., a neural network) to determine a probability that the digital image includes or depicts content that is unsafe (e.g., inappropriate or not safe for work). The text understanding system 102 further compares the unsafe probability with a safety probability threshold (p(unsafe)<0.5) to determine whether to select or filter out the image.

To further improve selected digital images for training data, the text understanding system 102 performs image clustering 310. To elaborate, the text understanding system 102 performs the image clustering 310 by (randomly) sampling or selecting a subset of text-rich digital images that satisfy the probability threshold(s) of the threshold comparison 308. For example, the text understanding system 102 samples 50 k digital images and clusters them into a number (e.g., 100) of clusters, each corresponding to its own image classification. In some cases, the text understanding system 102 performs the image clustering 310 using an image clustering model or an image classification model (e.g., a neural network) that classifies or clusters the digital images according to visual features.

As further illustrated in FIG. 3, the text understanding system 102 performs (or receives an indication of) cluster selection 312. More particularly, the text understanding system 102 selects a subset of the image clusters (e.g., 14 of the 100) to use for inclusion in pretraining data. For example, the text understanding system 102 selects image clusters corresponding to text-rich image classifications. In some cases, a text-rich image classification includes or refers to an image classification corresponding to (or including images depicting) text-rich content. Example text-rich image classifications include posters, covers, advertisements, infographics, educational materials, and logos. Indeed, in one or more embodiments, the text understanding system 102 selects clusters with labels indicating text-rich content—where images clustered into the classifications are likely to depict text-rich content.

As shown in FIG. 3, the text understanding system 102 utilizes an optical character recognition model 314 to process images in one or more selected clusters. The text understanding system 102 utilizes the optical character recognition model 314 to detect and extract text glyphs or characters from pixels of digital images. By using the optical character recognition model 314 to extract text from a digital image, the text understanding system 102 thus generates a ground truth text phrase 316. Indeed, the text understanding system 102 generates the ground truth text phrase 316 to use as training data together with its corresponding digital image (e.g., the image from which the text is extracted using the optical character recognition model 314).

In some embodiments, the text understanding system 102 resizes digital images selected or sampled from text-rich image classifications. For instance, the text understanding system 102 resizes a digital image from its original resolution (e.g., 10242 pixels) to a resized resolution (e.g., 384 pixels on the short edge of the image) compatible with vision encoders of a vision-language model (e.g., many vision encoders are compatible up to a resolution of (e.g., 336² pixels). Resizing images improves performance and prevents the optical character recognition model 314 from recognizing characters that are not visible (e.g., too small) to vision encoders.

By selecting digital images from text-rich image classifications and applying the optical character recognition model 314 to extract ground truth text phrases, the text understanding system 102 thus generates a pretraining dataset 318 (e.g., including 422 k text-rich images and their ground truth text phrases). In one or more embodiments, the text understanding system 102 determines (e.g., using the optical character recognition model 314) geometric relationships between recognized words and merges the words to generate the ground truth text phrase 316 according to merging rules based on the geometric relationships. In some cases, the text understanding system 102 further balances the training data by limiting the number of images selected from a single cluster or text-rich image classification to a threshold number (e.g., 52 k) to sample across multiple classifications.

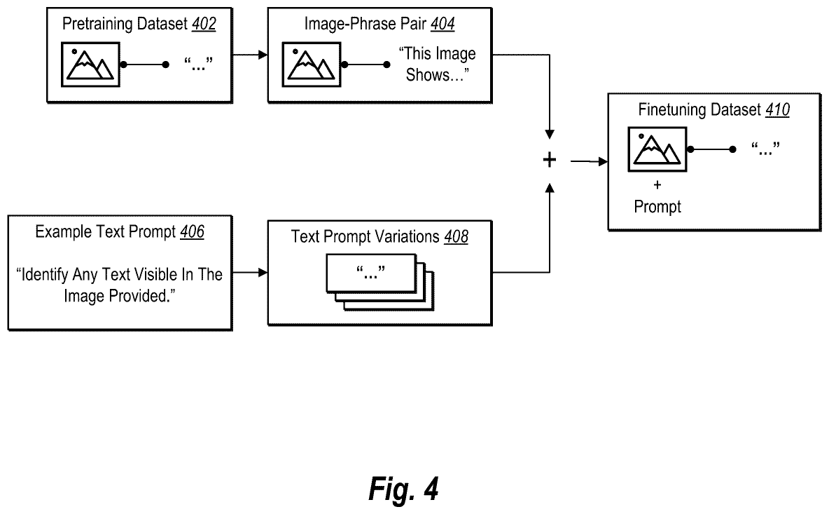

As noted above, in certain embodiments, the text understanding system 102 generates a finetuning dataset for training a vision-language model. In particular, the text understanding system 102 generates a finetuning dataset for modifying parameters of components of a vision-language model during a finetuning stage. FIG. 4 illustrates an example process of generating a finetuning dataset in accordance with one or more embodiments.

As illustrated in FIG. 4, the text understanding system 102 accesses a pretraining dataset 402 (e.g., the pretraining dataset 318). In particular, the text understanding system 102 accesses the pretraining dataset 402 that stores digital images and corresponding ground truth text phrases. As shown, the text understanding system 102 thus identifies or accesses an image-phrase pair 404 from the pretraining dataset 402. For instance, the text understanding system 102 identifies an image-phrase pair 404 that includes a text-rich digital image and its ground truth text phrase.

As further illustrated in FIG. 4, the text understanding system 102 identifies an example text prompt 406. Indeed, the text understanding system 102 identifies the example text prompt 406 (e.g., “Identify any text visible in the image provided.”) that defines a text-based input for prompting a vision-language model to determine text shown in a digital image. In some embodiments, the text understanding system 102 generates a set of text prompt variations 408 from the example text prompt 406, where each variation instructs a vision-language model with the same end goal using different language. Example text prompt variations include: i) “List all the text you can see in the given image,” ii) “Enumerate the words or sentences visible in the picture,” iii) “describe any readable text present in the image,” iv) “describe any readable text present in the image,” v) “report any discernible text you see in the image,” vi) “share any legible words or sentences visible in the picture,” vii) “provide a list of texts observed in the provided image, viii) “note down any readable words or phrases shown in the photo,” ix) report on any text that can be clearly read in the image,” and x) “mention any discernible and legible text present in the given picture.”

As further shown in FIG. 4, the text understanding system 102 generates a finetuning dataset 410 from image-phrase pairs and the text-prompt variations 408. For example, the text understanding system 102 selects the image-phrase pair 404 and a text prompt variation as a single instance of input data for the finetuning dataset 410. The text understanding system 102 thus generates the finetuning dataset 410 that includes instances of image-phrase pairs and accompanying text prompt variations, where the text prompt variations instruct the vision-language model to recreate the ground truth text phrases from the digital images in the image-phrase pairs. Accordingly, the finetuning dataset 410 includes noisy instruction-following data made up of digital images, text phrase prompts, and ground truth text phrases.

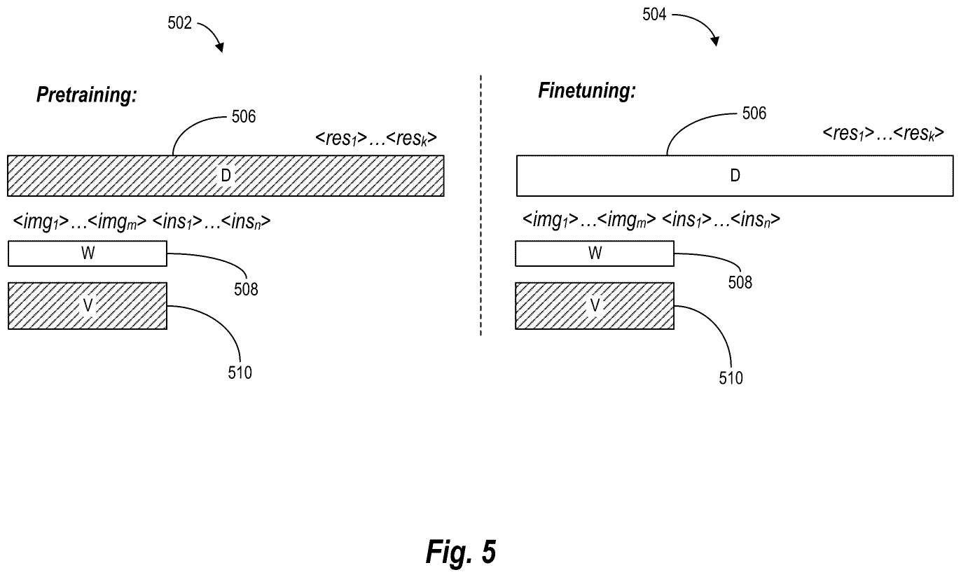

As mentioned above, in certain described embodiments, the text understanding system 102 trains a vision-language model using pretraining data and finetuning data. In particular, the text understanding system 102 implements a two-stage training process that includes a pretraining stage and a finetuning stage, each with respective datasets, for modifying parameters of components within the architecture of a vision-language model. FIG. 5 illustrates an example diagram of a two-stage training process for modifying parameters of a vision-language model.

As illustrated in FIG. 5, the text understanding system 102 performs a pretraining stage 502. Within the pretraining stage 502, the text understanding system 102 provides pretraining data to vision-language model that includes a language decoder 506 (represented by D), a projection matrix 508 (represented by W), and a vision tower 510 (which includes a high-resolution vision encoder and a low-resolution vision encoder and which is represented by V). Specifically, the text understanding system 102 provides text-rich digital images (or image tokens extracted from text-rich images) represented by <img₁> . . . <imgₘ> along with text phrase prompts (or prompt tokens extracted from text phrase prompts) represented by <ins₁> . . . <insₙ>. The text understanding system 102 also provides target responses, or ground truth text phrases represented by <res₁> . . . <resₖ>.

As part of the pretraining stage 502, the text understanding system 102 freezes the language decoder 506 and the vision tower 510. Indeed, as indicated by the shading patterns of the vision-language model components, the white boxes indicate unfrozen (modifiable) components while the patterned boxes indicate frozen (un-modifiable) components. The text understanding system 102 thus freezes the language decoder 506 and the vision tower 510 during pretraining to prevent parameter modification. Accordingly, during the pretraining stage 502, the text understanding system 102 modifies only parameters of the projection matrix 508 (and a cross-attention layer) to modify parameters for feature alignment.

In some cases, the text understanding system 102 utilizes one or more loss functions, such as contrastive loss functions, cross-entropy loss functions, L2 loss functions (and/or other loss functions for different components or stages of a vision-language model) to compare a predicted text phrase with a ground truth text phrase. The text understanding system 102 thus utilizes the loss functions to motivate or encourage the projection matrix 508 to project visual features from the vision tower 510 into an embedding space of the language decoder 506 for accurate replication of ground truth text phrases from input digital images (and/or accompanying text phrase prompts). Indeed, over training iterations, the text understanding system 102 re-determines measures of loss for comparing predicted text phrases with ground truth text phrases and updates parameters to reduce the loss until satisfying a loss threshold (and/or a threshold number of iterations).

As further illustrated in FIG. 5, the text understanding system 102 performs a finetuning stage 504. Within the finetuning stage 504, the text understanding system 102 provides finetuning data to the language decoder 506, the projection matrix 508, and the vision tower 510. As noted, the text understanding system 102 provides text-rich digital images (or image tokens extracted from text-rich images) represented by <img₁> . . . <imgₘ> along with text phrase prompts (or prompt tokens extracted from text phrase prompts) represented by <ins₁> . . . <insₙ>. The text understanding system 102 also provides target responses, or ground truth text phrases represented by <res₁> . . . <resₖ>.

As part of the finetuning stage 504, the text understanding system 102 freezes the vision tower 510 to prevent modification of parameters for the high-resolution vision encoder and the low-resolution vision encoder. During finetuning, the text understanding system 102 modifies or updates parameters of the language decoder 506 and the projection matrix 508 (and a cross-attention layer) for feature alignment. For example, the text understanding system 102 utilizes one or more loss functions to compare predicted text phrases with ground truth text phrases. The text understanding system 102 thus utilizes loss functions to motivate or encourage the projection matrix 508 and the language decoder 506 to generate accurate replications of ground truth text phrases from input digital images (and/or accompanying text phrase prompts). Indeed, over training iterations, the text understanding system 102 re-determines measures of loss for comparing predicted text phrases with ground truth text phrases and updates parameters to reduce the loss until satisfying a loss threshold (and/or a threshold number of iterations).

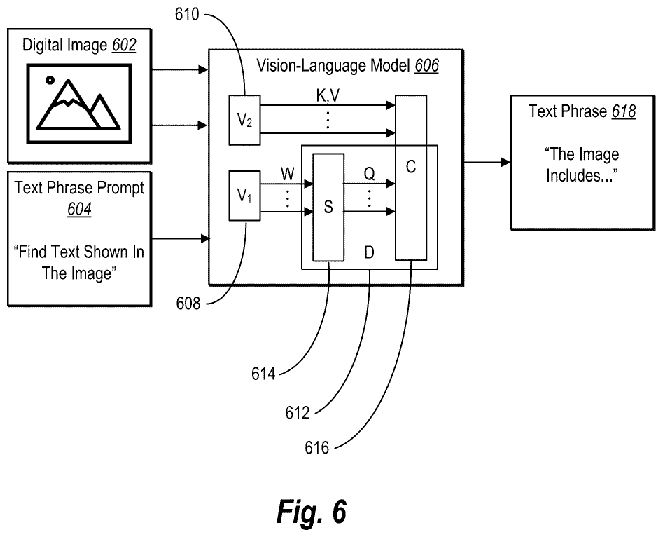

As mentioned, in certain embodiments, the text understanding system 102 utilizes a trained vision-language model to generate a text phrase from a digital image. In particular, the text understanding system 102 utilizes a vision-language model with a unique architecture to generate a text phrase that reflects, repeats, or describes text-rich content depicted in a digital image. FIG. 6 illustrates an example diagram of using a vision-language model with a unique dual-vision-encoder architecture to generate a text phrase in accordance with one or more embodiments.

As illustrated in FIG. 6, the text understanding system 102 inputs a digital image 602 and a text phrase prompt 604 into a vision-language model 606. In turn, the vision-language model 606 processes the digital image 602 and the text phrase prompt 604 to generate a text phrase 618. To generate the text phrase 618, the vision-language model 606 extracts visual features from the digital image 602 and textual features from the text phrase prompt 604. Indeed, the vision-language model 606 includes internal neural network components or layers designed to extract features for providing to a language decoder 612 which ultimately generates the text phrase 618.

As shown, the vision-language model 606 includes a low-resolution vision encoder 608 (represented by V₁). The low-resolution vision encoder 608 extracts low-resolution visual features from the digital image 602. Specifically, the low-resolution vision encoder 608 extracts visual features below a resolution threshold. In some cases, the low-resolution vision encoder 608 extracts features at a resolution of up to 336² pixels.

In addition, the vision-language model 606 includes a high-resolution vision encoder 610 (represented by V₂). The high-resolution vision encoder 610 extracts high-resolution visual features from the digital image 602, includes resolutions higher than 336² pixels. For example, the high-resolution vision encoder 610 extracts visual features at a resolution of 10242 pixels, at HD resolution (e.g., 1920×1080), at 4k resolution, at 8k resolution, or at some other resolution. In addition, the high-resolution vision encoder 610 supports outputs of up to 2048 visual features.

As further shown in FIG. 6, the vision-language model 606 includes a language decoder 612 (represented by D). The language decoder 612 processes prompt features extracted from the text phrase prompt 604. For example, in some cases, the vision-language model 606 includes a prompt encoder that encodes or extracts prompt embeddings form the text phrase prompt, embedding the features in an embedding space. In turn, the language decoder 612 processes the embeddings (concatenated with other embeddings) to generate output text phrases. In some cases, the language decoder 612 includes a self-attention layer 614 (represented by S) to extract and/or process prompt features that encode relationship data or context data from the words and characters of the text phrase prompt 604.

As also shown, the vision-language model 606 includes a trainable projection matrix (represented by W). The projection matrix transforms or projects low-resolution visual features extracted by the low-resolution vision encoder 608. Specifically, the projection matrix transforms the low-resolution visual features into an embedding space of the language decoder 612. In some embodiments, the text understanding system 102 further concatenates the transformed low-resolution visual features with prompt features to generate input embeddings for the language decoder 612 in the language decoder embedding space. In some embodiments, the text understanding system 102 also concatenates high-resolution visual features to the prompt features and the transformed low-resolution features to generate the input embeddings for the language decoder 612. However, in many cases the high-resolution features are too long for the input sequence limitations of the language decoder 612.

To accommodate the length of the high-resolution patch features (e.g., thousands of visual features long), together with text prompt features and low-resolution visual features, the text understanding system 102 transforms or converts high-resolution visual features into a form compatible with the language decoder 612. Indeed, some large language models are limited to a maximum input sequence length of 2048 or 4096 characters, so the text understanding system 102 utilizes a modified architecture to adapt extracted features to fit a sequence length threshold (where the high-resolution visual features would otherwise occupy the entire input sequence). For example, the vision-language model 606 includes a cross-attention layer 616 (represented by C) that transforms or converts high-resolution visual features into key-value pairs compatible with the embedding space and sequence length constraints of the language decoder 612.

As just mentioned, the text understanding system 102 extracts, transforms, and concatenates visual features into an embedding space of the language decoder 612. For example, the text understanding system 102 generates an input embedding (including transformed low-resolution visual features, key-value pairs, and extracted prompt features) for the language decoder 612. In some cases, the text understanding system 102 generates the input embedding according to the following formulas:

$$\begin{matrix}emb ( 〈 {img}_{1} 〉 ) , … , emb ( 〈 {img}_{m} 〉 ) = {WV}_{1} ( I ) \\ input\_emb = concat ( [ emb ( 〈 {img}_{1} 〉 ) , … , emb ( 〈 {img}_{m} 〉 ) , emb ( 〈 {ins}_{1} 〉 ) , … , emb ( 〈 {ins}_{n} 〉 ) ] )\end{matrix}$$

where input_emb represents the input embedding for the language decoder 612, WV₁(I) represents the project-matrix-transformed version of the low-resolution visual features extracted from the digital image 602 (represented by I). In some cases, the low-resolution visual features are grid characteristics before a final transformer layer in the low-resolution vision encoder 608.

In addition to (and concurrently with) generating the input embedding from the low-resolution visual features and the prompt features, the text understanding system 102 further uses the cross-attention layer 616 to transform or convert high-resolution visual features (from the high-resolution vision encoder 610) to key-value pairs. For example, the text understanding system 102 generates key-value pairs according to the following formula:

$$CrossAttention ( h , {V}_{2} , I ) = softmax ( \frac{{Q}^{j} {{h}^{j} ( {K}^{j} {V}_{2} ( I ) )}^{T}}{\sqrt{d}} ) {V}^{j} {V}_{2} ( I )$$

where Q^{j}, K^{j}, and V represents a query/key/value projection matrix in the j^{th} transformation layer, and where h represents the hidden state before the cross-attention layer 616 in layer j. In some embodiments, the vision-language model 606 includes a pre-attention LayerNorm before calculating the attention and another output projection matrix O^{j} to project the aggregated values back to the hidden space. In certain cases, the language decoder 612 has a self-attention layer 614 in every transformer layer. To prevent the random initialization of the cross-attention layer 616 from hurting original language generation capability, the text understanding system 102 initializes the value projection matrix V^{j} as a zero matrix and the output projection matrix O^{j} as an identity matrix. Using the key-value pairs (of the query/key/value projection matrix) and the concatenated input embedding, the language decoder 612 thus generates a text phrase 618. The text phrase 618 indicates or reflects text depicted in text-rich content of the digital image 602.

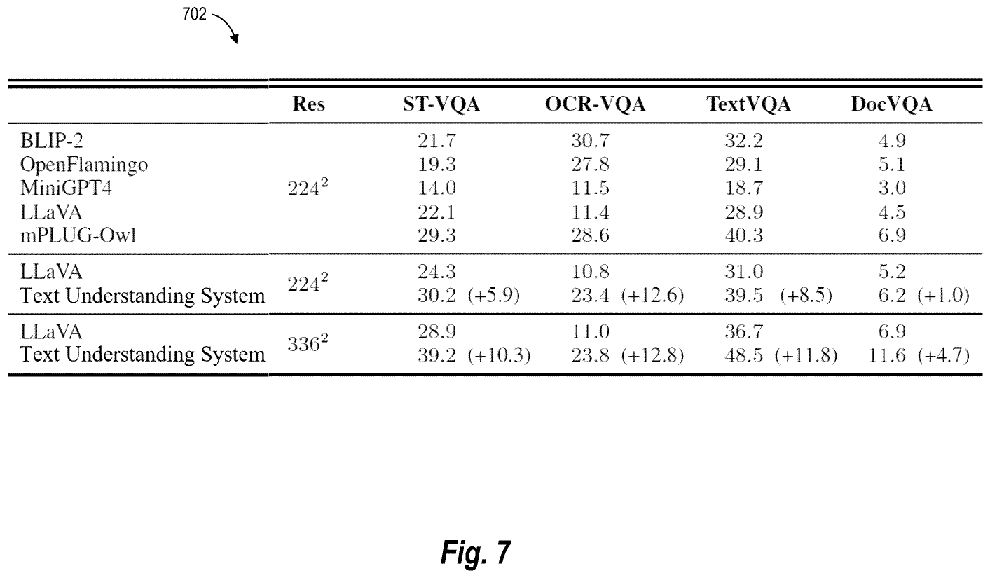

As mentioned above, in certain embodiments, the text understanding system 102 improves performance in generating text phrases from digital images depicting text-rich content. Experimenters have demonstrated accuracy improvements of the text understanding system 102, testing various embodiments against different prior systems. FIG. 7 illustrates an example table of experimental results comparing the text understanding system 102 against prior systems.

As illustrated in FIG. 7, the table 702 includes experimental results for various systems test on text-based visual question answering (VQA) datasets. The table 702 also includes results for models operating at different resolutions, such as 224² and 336². To generate the results of the table 702, experimenters applied various models to samples from datasets including: i) an ST-VQA dataset (described by Ali Furkan Biten et al. in ICDAR 2019 Competition on Scene Text Visual Question Answering (2019)), ii) an OCR-VQA dataset (described by Anand Mishra et al. in OCR-VQA: Visual Question Answering by Reading Text in Images, 2019 Conf. on Document Analysis and Recognition, pathogenicity prediction. 947-52 (2019)), iii) a TextVQA dataset (described by Amanpreet Singh et al. in Towards VQA Models that can Read, 2019 Conf. on Computer Vision and Pattern Recognition (2019)), and iv) a DocVQA dataset (described by Minesh Mathew et al. in DOCVQA: A Dataset for VQA on Document Images (2020)). The table 702 shows accuracy (in percentages %) generating text phrases that include (or match) ground truth text phrases.

For example, table 702 includes results for a BLIP-2 model, as described by Junnan Li et al. in BLIP-2: Bootstrapping Language-Image Pre-training with Frozen Image Encoders and Large Language Models (2023). In addition, the table 702 includes results for an OpenFlamingo model, as described by Anas Awadalla et al. in Openflamingo (2023). Further, the table 702 includes results for a MiniGPT4 model, as described by Deyao Zhu et al. in MiniGPT-4: Enhancing Vision-Language Understanding with Advanced Large Language Models (2023). The table 702 also includes results for a LLaVA model, as described by Haotian Liu et al. in Visual Instruction Tuning (2023). Additionally, the table 702 includes results for an mPLUG-Owl model, as described by Qinghao Ye et al. in mPLUG-Owl: Modularization Empowers Large Language Models with MultiModality (2023).

Based on the experiments, one or more embodiments of the text understanding system 102 exhibit significant accuracy improvements over the prior systems enumerated above. Indeed, look especially to the higher resolution of 336², the text understanding system 102 generates results with far greater accuracy than the LLaVA model. The text understanding system 102 also improves accuracy on generated text phrases at lower resolutions compared to many of the prior systems across the various datasets.

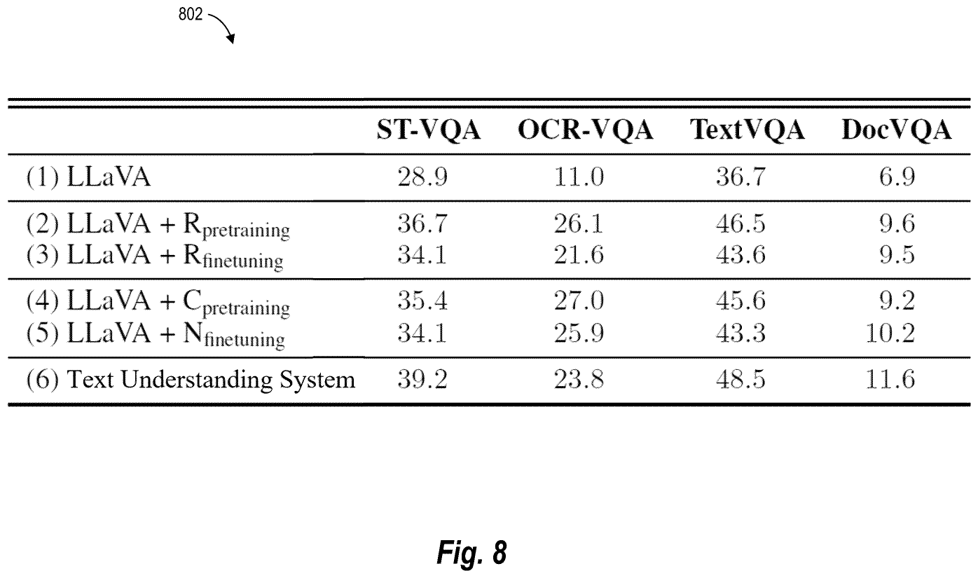

As noted, in certain embodiments, certain aspects of the text understanding system 102 provide various advantages over prior systems. In particular, experimenters have performed ablation studies on embodiments of the text understanding system 102 to determine accuracy improvements provided by the different training data, training processes, and/or architectural components of the text understanding system 102 described herein. FIG. 8 illustrates an example table of ablation study results in accordance with one or more embodiments.

As illustrated in FIG. 8, the table 802 includes experimental results for the original LLaVA model (1), results for variations of the LLaVA model (2)-(5) using certain aspects of the text understanding system 102 described herein, and results for the text understanding system 102 (6). Experimenters tested the various models across the same datasets enumerated above in relation to FIG. 7. As shown, R_{pretraining} represents using a pretraining dataset described above and R_{finetuning} represents using a finetuning dataset described above. In addition, C_{pretraining} represents using captions as ground truth instead of optical character recognition results during pretraining. N_{finetuning} represents using written questions together with optical character recognition results instead of the standard instruction finetuning dataset. All results are shown in percent accuracy (%) for 336²-based models. As shown, the text understanding system 102 outperforms other models, and using variations of pretraining and finetuning datasets also improves performance.

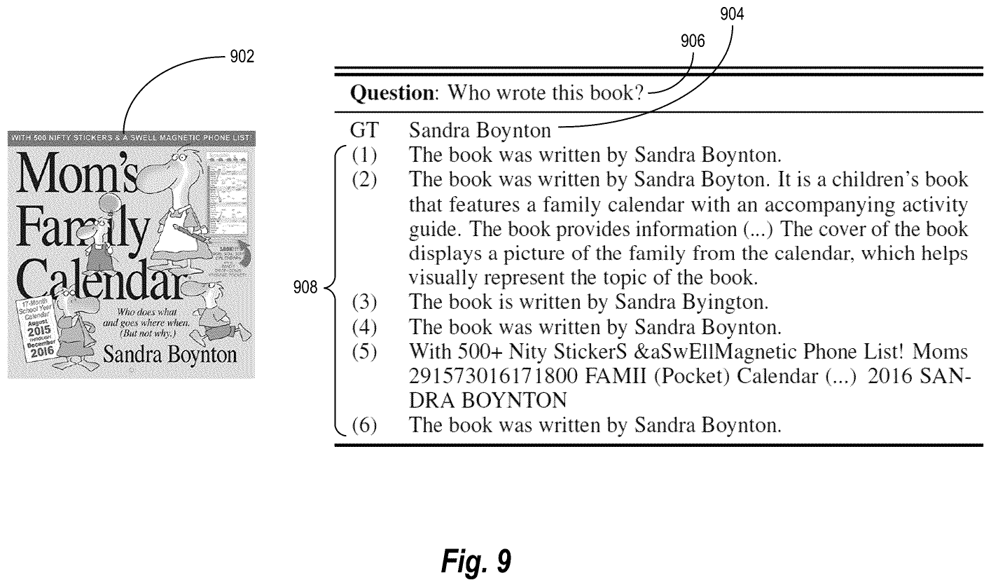

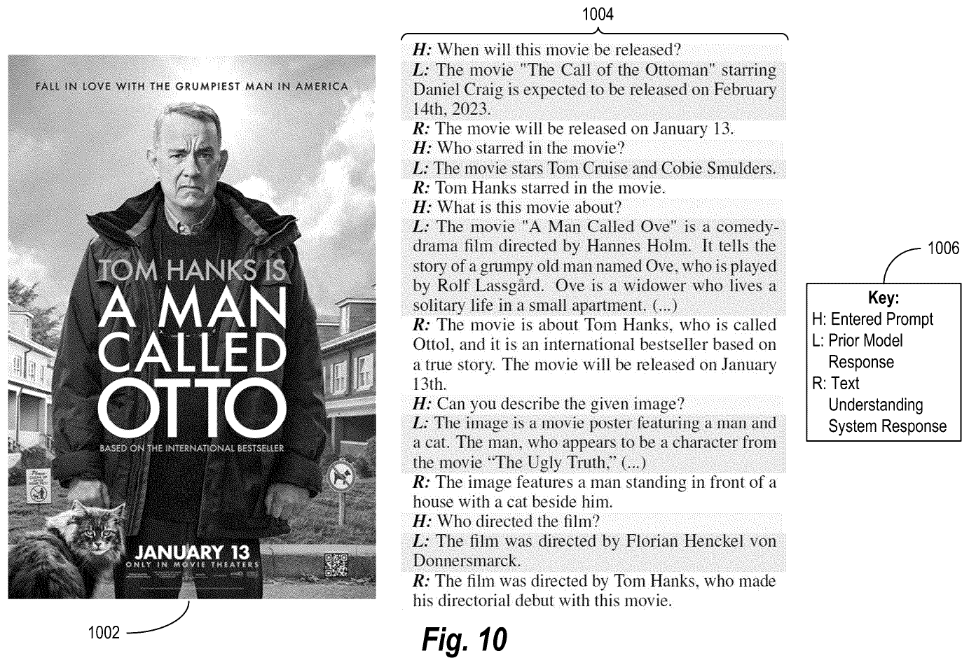

In addition to quantitative experimental results, experimenters also performed qualitative experiments to demonstrate improvements of the text understanding system 102 and various ablations. FIGS. 9-10 illustrate qualitative results from experiments testing models in generating text phrases from digital images in accordance with one or more embodiments.

As illustrated in FIG. 9, the digital image 902 includes or depicts text-rich content and is sampled from the OCR-VQA dataset. Indeed, the digital image 902 is an image of a book cover, depicting text for the book title, an author's name, and a caption. As shown, some of the text is occluded by other objects or graphics. Experimenters provided the digital image 902 to each of the models (1)-(6) enumerated in table 802 of FIG. 8, along with the text phrase prompt 904 instructing the models to identify the author. As shown, ground truth text phrase 906 is “Sandra Boynton.” The results of generated text phrases 908 vary across the different models, with some models generating nonsensical results, some generating results from text not related to the author, and others generating results that are nearly correct but that include incorrect characters or other errors. The text understanding system 102, shown in (6), generates an accurate, correct sentence properly identifying the author of the book shown in the digital image 902.

As illustrated in FIG. 10, experimenters tested the performance of a prior model (e.g., the LLaVA model) against the performance of the text understanding system 102 in a conversation about a digital image 1002. Specifically, experimenters provided the digital image 1002 to a prior model and to the text understanding system 102. In addition, experimenters provided a series of text phrase prompts instructing the models to generate text phrases from content depicted in the digital image 1002. As indicated by the key 1006, the conversation 1004 includes entered text phrase prompts (denoted by H), responses generated by the prior LLaVA model (denoted by L), and responses generated by the text understanding system 102 (denoted by R). Comparing the responses from the two models, the text understanding system 102 generates more accurate text phrases from the text content of the digital image 1002, while the LLaVA model responses include drastic errors in several places. For example, the LLaVA model incorrectly identifies the title of the move, the release date of the movie, and the star of the movie, while the text understanding system 102 correctly generates responses for each.

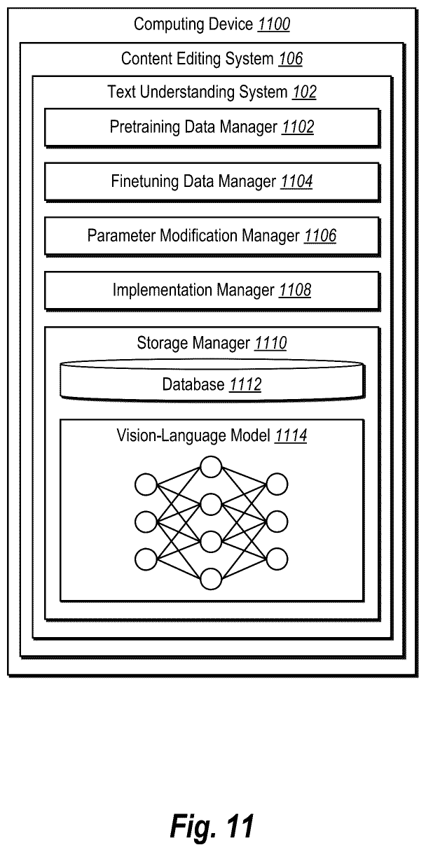

Looking now to FIG. 11, additional detail will be provided regarding components and capabilities of the text understanding system 102. Specifically, FIG. 11 illustrates an example schematic diagram of the text understanding system 102 on an example computing device 1100 (e.g., one or more of the client device 108 and/or the server(s) 104). In some embodiments, the computing device 1100 refers to a distributed computing system where different managers are located on different devices, as described above. As shown in FIG. 11, the text understanding system 102 includes a pretraining data manager 1102, a finetuning data manager 1104, a parameter modification manager 1106, and implementation manager 1108, and a storage manager 1110.

As just mentioned, the text understanding system 102 includes a pretraining data manager 1102. In particular, the pretraining data manager 1102 generates, identifies, refines, determines, or selects pretraining data for a pretraining dataset. For example, the pretraining data manager 1102 determines digital images with at least a threshold probability of depicting text-rich content. In addition, the pretraining data manager 1102 clusters digital images into text-rich image classifications. Further, the pretraining data manager 1102 utilizes an optical character recognition model to generate ground truth text phrases from text-rich digital images, as described above.

As shown, the text understanding system 102 includes a finetuning data manager 1104. In particular, the finetuning data manager 1104 generates, identifies, refines, determines, or selects finetuning data for a finetuning dataset. For example, the finetuning data manager 1104 generates, identifies, or selects text prompts to pair with digital images and their corresponding ground truth text phrases. In some cases, the finetuning data manager 1104 generates or selects the text prompts as text prompt variations of an example text prompt instructing a vision-language model (e.g., the vision-language model 1114) to generate a text phrase from an accompanying digital image.

Additionally, the text understanding system 102 includes a parameter modification manager 1106. In particular, the parameter modification manager 1106 modifies, updates, adjusts, determines, learns, trains, or tunes parameters of a vision-language model (e.g., the vision-language model 1114). For example, the parameter modification manager 1106 communicates with the pretraining data manager 1102 and the finetuning data manager 1104 to access training data to modify parameters of the vision-language model 1114. In some cases, the parameter modification manager 1106 performs a two-stage training process involving a pretraining stage and a finetuning stage, freezing different components at each stage, as described herein.

As further illustrated, the text understanding system 102 includes an implementation manager 1108. In particular, the implementation manager 1108 utilizes, implements, or applies the vision-language model 1114 to generate a text phrase from a digital image. For example, the implementation manager 1108 utilizes the vision-language model 1114 to process an input digital image and an input text phrase prompt, whereupon the vision-language model 1114 generates an output text phrase from text-rich content depicted in the digital image as instructed by the input text phase prompt.

The text understanding system 102 further includes a storage manager 1110. The storage manager 1110 operates in conjunction with, or includes, one or more memory devices such as the database 1112 (e.g., the database 114) that store various data such as training digital images, text prompt variations, and ground truth text phrases. As shown, the database 1112 stores a vision-language model 1114 accessing and usable by other components of the text understanding system 102. In some cases, the vision-language model 1114 includes a dual-vision-encoder architecture as described herein. The storage manager 1110 communicates with the other components of the text understanding system 102 to facilitate the operations and functions described herein.

In one or more embodiments, each of the components of the text understanding system 102 are in communication with one another using any suitable communication technologies. Additionally, the components of the text understanding system 102 is in communication with one or more other devices including one or more client devices described above. It will be recognized that although the components of the text understanding system 102 are shown to be separate in FIG. 11, any of the subcomponents may be combined into fewer components, such as into a single component, or divided into more components as may serve a particular implementation. Furthermore, although the components of FIG. 11 are described in connection with the text understanding system 102, at least some of the components for performing operations in conjunction with the text understanding system 102 described herein may be implemented on other devices within the environment.

The components of the text understanding system 102, in one or more implementations, includes software, hardware, or both. For example, the components of the text understanding system 102 include one or more instructions stored on a computer-readable storage medium and executable by processors of one or more computing devices (e.g., the computing device 1100). When executed by the one or more processors, the computer-executable instructions of the text understanding system 102 cause the computing device 1100 to perform the methods described herein. Alternatively, the components of the text understanding system 102 comprises hardware, such as a special purpose processing device to perform a certain function or group of functions. Additionally, or alternatively, the components of the text understanding system 102 includes a combination of computer-executable instructions and hardware.

Furthermore, the components of the text understanding system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the text understanding system 102 may be implemented as part of a stand-alone application on a personal computing device or a mobile device. Alternatively, or additionally, the components of the text understanding system 102 may be implemented in any application that allows creation and delivery of marketing content to users, including, but not limited to, applications in ADOBE® EXPERIENCE MANAGER and CREATIVE CLOUD®, such as PHOTOSHOP®, ILLUSTRATOR®, and INDESIGN®. “ADOBE,” “ADOBE EXPERIENCE MANAGER,” “CREATIVE CLOUD,” “PHOTOSHOP,” “ILLUSTRATOR,” and “INDESIGN” are either registered trademarks or trademarks of Adobe Inc. in the United States and/or other countries.

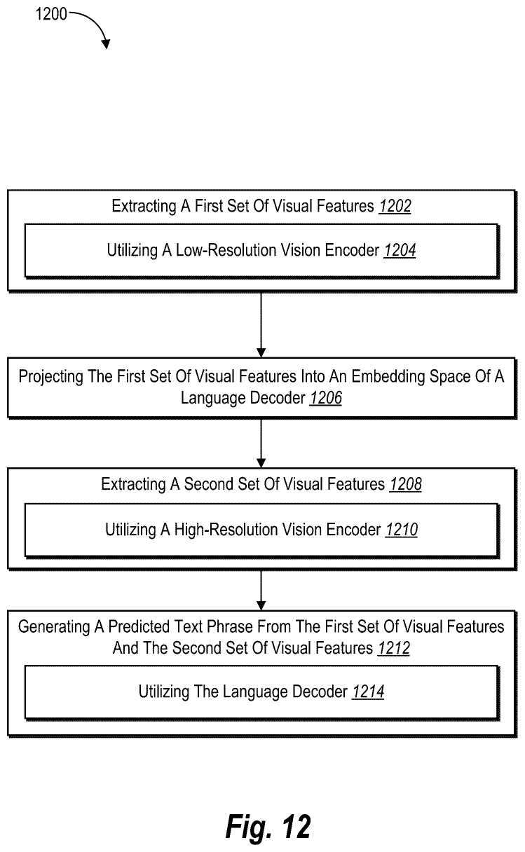

FIGS. 1-11 the corresponding text, and the examples provide a number of different systems, methods, and non-transitory computer readable media for training and utilizing a vision-language model based on pretraining and finetuning data to generate text phrases from text-rich digital images. In addition to the foregoing, embodiments are describable in terms of flowcharts comprising acts for accomplishing a particular result. For example, FIGS. 12-14 illustrate flowcharts of example sequences or series of acts in accordance with one or more embodiments.

While FIGS. 12-14 illustrate acts according to particular embodiments, alternative embodiments may omit, add to, reorder, and/or modify any of the acts shown in FIGS. 12-14. The acts of FIGS. 12-14 are sometimes performed as part of a method. Alternatively, a non-transitory computer readable medium comprises instructions, that when executed by one or more processors, cause a computing device to perform the acts of FIGS. 12-14. In still further embodiments, a system performs the acts of FIGS. 12-14. Additionally, the acts described herein may be repeated or performed in parallel with one another or in parallel with different instances of the same or other similar acts.

FIG. 12 illustrates an example series of acts 1200 for utilizing a vision-language model to generate a predicted text phrase from a digital image according to parameters learned from digital images with at least a threshold probability of depicting text-rich content. In particular, the series of acts 1200 includes an act 1202 of extracting a first set of visual features. For example, the act 1202 includes an act 1204 of utilizing a low-resolution vision encoder. In some cases, the act 1202 involves extracting, utilizing a vision-language model comprising a projection matrix and a language decoder, a first set of visual features from a digital image depicting text-rich content. The act 1204 involves extracting the first set of visual features comprises utilizing a low-resolution vision encoder to extract low-resolution visual features.

As shown, the series of acts 1200 includes an act 1206 of projecting the first set of visual features into an embedding space of a language decoder. For example, the act 1206 involves projecting the first set of visual features into an embedding space of the language decoder utilizing the projection matrix comprising parameters learned from digital images with at least a threshold probability of depicting text-rich content. In addition, the series of acts 1200 includes an act 1208 of extracting a second set of visual features. For example, the act 1208 includes an act 1210 of utilizing a high-resolution vision encoder. In some embodiments, the act 1208 involves extracting, utilizing the vision-language model, a second set of visual features from the digital image depicting the text-rich content. Additionally, the act 1210 involves extracting the second set of visual features comprises utilizing a high-resolution vision encoder to extract high-resolution visual features at a resolution higher than the low-resolution visual features.

As further shown, the series of acts 1200 includes an act 1212 of generating a predicted text phrase from the first set of visual features and the second set of visual features. In some cases, the act 1212 includes an act 1214 of utilizing the language decoder. For example, the act 1212 involves generating, from the first set of visual features projected into the embedding space of the language decoder and from the second set of visual features, a predicted text phrase from the text-rich content depicted in the digital image utilizing the language decoder of the vision-language model to process the digital image according to parameters learned from ground truth text phrases generated using an optical character recognition model to process the digital images with at least the threshold probability of depicting text-rich content.

In some embodiments, the series of acts 1200 includes an act of determining the digital images with at least the threshold probability of depicting text-rich content by utilizing an image text detection model to determine probabilities of the digital images depicting text-rich content. In these or other embodiments, the series of acts 1200 includes an act of projecting the first set of visual features into the embedding space of the language decoder by utilizing the projection matrix comprising parameters learned from a subset of digital images from among the digital images with at least the threshold probability of depicting text-rich content, wherein the subset of digital images corresponds to a set of text-rich image classifications.

In one or more embodiments, the series of acts 1200 includes an act of generating the ground truth text phrases using the optical character recognition model to process the subset of digital images corresponding to the set of text-rich image classifications. Further, the series of acts 1200 includes an act of determining the digital images with at least the threshold probability of depicting text-rich content. The series of acts 1200 also includes acts of clustering the digital images according to image classifications and selecting a subset of the digital images from clusters corresponding to text-rich image classifications.

Additionally, the series of acts 1200 includes acts of determining a text phrase prompt that instructs the vision-language model to generate the predicted text phrase from the digital image and generating the predicted text phrase utilizing the vision-language model to process the text phrase prompt and the digital image. Further, the series of acts 1200 includes an act of generating the predicted text phrase from the low-resolution visual features and the high-resolution visual features.

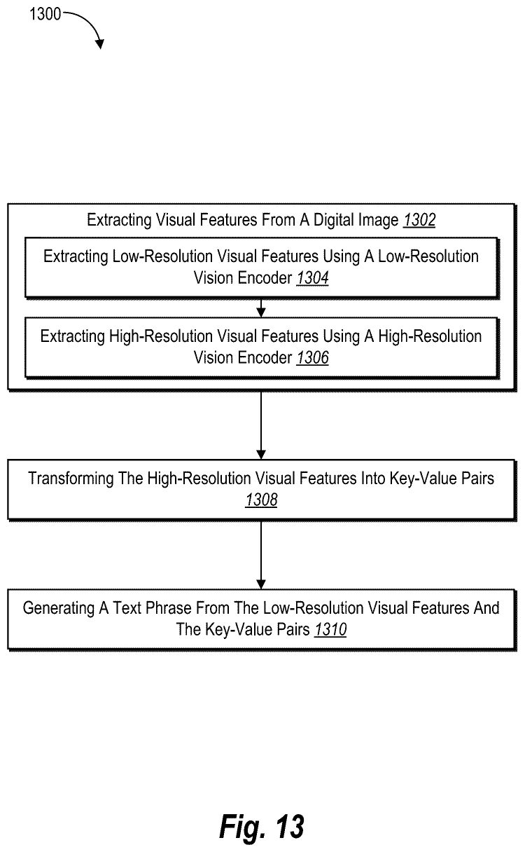

FIG. 13 illustrates an example series of acts 1300 for utilizing a vision-language model to generate a text phrase from a digital image. In particular, the series of acts 1300 includes an act 1302 of extracting visual features from a digital image. For example, the act 1302 includes an act 1304 of extracting low-resolution visual features using a low-resolution vision encoder. In some cases, the act 1304 involves extracting, from a digital image utilizing the low-resolution vision encoder of the vision-language model, low-resolution visual features compatible with the language decoder. In addition, the series of acts 1302 includes an act 1306 of extracting high-resolution visual features using a high-resolution vision encoder. In some cases, the act 1306 involves extracting high-resolution visual features from the digital image utilizing the high-resolution vision encoder of the vision-language model.

In some embodiments, the series of acts 1300 includes an act 1308 of transforming the high-resolution visual features into key-value pairs. For example, the act 1308 involves transforming, utilizing the cross-attention layer of the vision-language model, the high-resolution visual features into key-value pairs compatible with the language decoder. In certain cases, the series of acts 1300 includes an act 1310 of generating a text phrase from the low-resolution visual features and the key-value pairs. For instance, the act 1310 involves generating, from the low-resolution visual features and the key-value pairs, a text phrase from text-rich content depicted in the digital image.

In one or more embodiments, the series of acts 1300 includes an act of receiving, from a client device, the digital image and a text phrase prompt comprising instructions for detecting text depicted in the digital image. In addition, the series of acts 1300 includes an act of extracting text embeddings from the text phrase prompt utilizing the language decoder of the vision-language model. In some cases, the series of acts 1300 includes an act of generating the text phrase from the text embeddings in addition to the low-resolution visual features and the high-resolution visual features. Further, the series of acts 1300 includes an act of transforming the low-resolution visual features into an embedding space of the language decoder utilizing a projection matrix of the vision-language model. Additionally, the series of acts 1300 includes an act of providing the text phrase for display with the digital image on a client device.

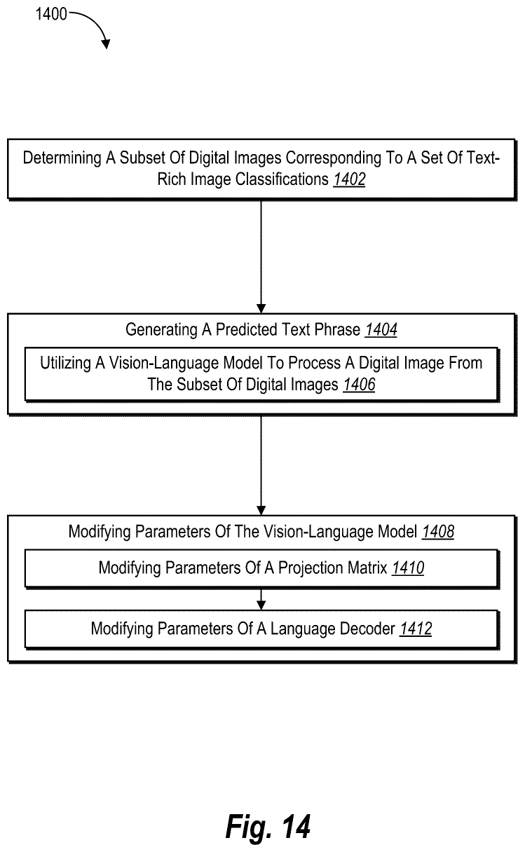

FIG. 14 illustrates an example series of acts 1400 for training a vision-language model to generate text phrases from text-rich digital images. In particular, the series of acts 1400 includes an act 1402 of determining a subset of digital images corresponding to a set of text-rich image classifications. For example, the act 1402 involves generating a pretraining dataset by selecting, from among a plurality of digital images with at least a threshold probability of depicting text-rich content, a subset of digital images corresponding to a set of text-rich image classifications. In addition, the series of acts 1400 includes an act 1404 of generating a predicted text phrase. For example, the act 1404 can include an act 1406 of utilizing a vision-language model to process a digital image form the subset of digital images. Indeed, the act 1404 involves generating a predicted text phrase from a digital image within the pretraining dataset utilizing a vision-language model comprising a low-resolution vision encoder, a high-resolution vision decoder, a language decoder, and a projection matrix for projecting features from the low-resolution vision encoder into an embedding space of the language decoder.

As shown, the series of acts 1400 includes an act 1408 of modifying parameters of the vision-language model. In particular, the act 1408 includes an act 1410 of modifying parameters of a projection matrix and an act 1412 of modifying parameters of a language decoder. For example, the act 1408 involves comparing the predicted text phrase with a ground truth text phrase for the digital image. In addition, the act 1410 involves modifying parameters of the projection matrix within the vision-language model based on comparing the predicted text phrase with the ground truth text phrase.

In some embodiments, series of acts 1400 includes an act of generating a finetuning dataset by determining, for one or more digital images within the subset of digital images corresponding to the set of text-rich image classifications, text phrase prompts that instruct the vision-language model to generate text phrases from the one or more digital images. In addition, the series of acts 1400 includes an act of generating predicted text phrases from the one or more digital images and the text phrase prompts utilizing the vision-language model. Further, the series of acts 1400 includes an act of comparing the predicted text phrases with ground truth text phrases corresponding to the one or more digital images and the text phrase prompts and an act of modifying the parameters of the projection matrix and parameters of the language decoder based on comparing the predicted text phrases with the ground truth text phrases.

In one or more embodiments, the series of acts 1400 includes an act of generating the finetuning dataset by: generating a resized digital image from the digital image among the subset of digital images corresponding to the set of text-rich image classifications, generating a ground truth text phrase by utilizing an optical character recognition model to process the resized digital image, and determining, to accompany the digital image as input to the vision-language model, a text phrase prompt comprising instructions for generating, from the digital image and the text phrase prompt, a text phrase to compare with the ground truth text phrase. Further, the series of acts 1400 includes an act of determining the text phrase prompt by randomly sampling the text phrase prompt from a set of text phrase prompt variations.

In some embodiments, the series of acts 1400 includes an act of generating the pretraining dataset by: determining, utilizing an image text detection model, probabilities of digital images depicting text-rich content, identifying, from the probabilities, the plurality of digital images with at least the threshold probability of depicting text-rich content, clustering the plurality of digital images according to image classifications, and selecting, from the plurality of digital images, the subset of digital images from clusters corresponding to text-rich image classifications. In some cases, the series of acts 1400 includes an act of modifying the parameters of the projection matrix by freezing the language decoder to prevent modifying decoder parameters based on the predicted text phrase.

Embodiments of the present disclosure may comprise or use a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) use transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 15 illustrates a block diagram of an example computing device 1500 that may be configured to perform one or more of the processes described above. One will appreciate that one or more computing devices, such as the computing device 1500 may represent the computing devices described above (e.g., computing device 1100, server(s) 104, and/or client device 108). In one or more embodiments, the computing device 1500 may be a mobile device (e.g., a mobile telephone, a smartphone, a PDA, a tablet, a laptop, a camera, a tracker, a watch, a wearable device, etc.). In some embodiments, the computing device 1500 may be a non-mobile device (e.g., a desktop computer or another type of client device). Further, the computing device 1500 may be a server device that includes cloud-based processing and storage capabilities.

As shown in FIG. 15, the computing device 1500 can include one or more processor(s) 1502, memory 1504, a storage device 1506, input/output interfaces 1508 (or “I/O interfaces 1508”), and a communication interface 1510, which may be communicatively coupled by way of a communication infrastructure (e.g., bus 1512). While the computing device 1500 is shown in FIG. 15, the components illustrated in FIG. 15 are not intended to be limiting. Additional or alternative components may be used in other embodiments. Furthermore, in certain embodiments, the computing device 1500 includes fewer components than those shown in FIG. 15. Components of the computing device 1500 shown in FIG. 15 will now be described in additional detail.

In particular embodiments, the processor(s) 1502 includes hardware for executing instructions, such as those making up a computer program. As an example, and not by way of limitation, to execute instructions, the processor(s) 1502 may retrieve (or fetch) the instructions from an internal register, an internal cache, memory 1504, or a storage device 1506 and decode and execute them.

The computing device 1500 includes memory 1504, which is coupled to the processor(s) 1502. The memory 1504 may be used for storing data, metadata, and programs for execution by the processor(s). The memory 1504 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1504 may be internal or distributed memory.

The computing device 1500 includes a storage device 1506 includes storage for storing data or instructions. As an example, and not by way of limitation, the storage device 1506 can include a non-transitory storage medium described above. The storage device 1506 may include a hard disk drive (HDD), flash memory, a Universal Serial Bus (USB) drive or a combination these or other storage devices.

As shown, the computing device 1500 includes one or more I/O interfaces 1508, which are provided to allow a user to provide input to (such as user strokes), receive output from, and otherwise transfer data to and from the computing device 1500. These I/O interfaces 1508 may include a mouse, keypad or a keyboard, a touch screen, camera, optical scanner, network interface, modem, other known I/O devices or a combination of such I/O interfaces 1508. The touch screen may be activated with a stylus or a finger.

The I/O interfaces 1508 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1508 are configured to provide graphical data to a display for presentation to a user. The graphical data may be representative of one or more graphical user interfaces and/or any other graphical content as may serve a particular implementation.

The computing device 1500 can further include a communication interface 1510. The communication interface 1510 can include hardware, software, or both. The communication interface 1510 provides one or more interfaces for communication (such as, for example, packet-based communication) between the computing device and one or more other computing devices or one or more networks. As an example, and not by way of limitation, communication interface 1510 may include a network interface controller (NIC) or network adapter for communicating with an Ethernet or other wire-based network or a wireless NIC (WNIC) or wireless adapter for communicating with a wireless network, such as a WI-FI. The computing device 1500 can further include a bus 1512. The bus 1512 can include hardware, software, or both that connects components of computing device 1500 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
extracting, utilizing a vision-language model comprising a projection matrix and a language decoder, a first set of visual features from a digital image depicting text-rich content;
projecting the first set of visual features into an embedding space of the language decoder utilizing the projection matrix comprising parameters learned from digital images with at least a threshold probability of depicting text-rich content;
extracting, utilizing the vision-language model, a second set of visual features from the digital image depicting the text-rich content; and
generating, from the first set of visual features projected into the embedding space of the language decoder and from the second set of visual features, a predicted text phrase from the text-rich content depicted in the digital image utilizing the language decoder of the vision-language model to process the digital image according to parameters learned from ground truth text phrases generated using an optical character recognition model to process the digital images with at least the threshold probability of depicting text-rich content.

2. The computer-implemented method of claim 1, further comprising determining the digital images with at least the threshold probability of depicting text-rich content by utilizing an image text detection model to determine probabilities of the digital images depicting text-rich content.

3. The computer-implemented method of claim 1, further comprising projecting the first set of visual features into the embedding space of the language decoder by utilizing the projection matrix comprising parameters learned from a subset of digital images from among the digital images with at least the threshold probability of depicting text-rich content, wherein the subset of digital images corresponds to a set of text-rich image classifications.

4. The computer-implemented method of claim 3, further comprising generating the ground truth text phrases using the optical character recognition model to process the subset of digital images corresponding to the set of text-rich image classifications.

5. The computer-implemented method of claim 1, further comprising:
determining the digital images with at least the threshold probability of depicting text-rich content;
clustering the digital images according to image classifications; and
selecting a subset of the digital images from clusters corresponding to text-rich image classifications.

6. The computer-implemented method of claim 1, further comprising:
determining a text phrase prompt that instructs the vision-language model to generate the predicted text phrase from the digital image; and
generating the predicted text phrase utilizing the vision-language model to process the text phrase prompt and the digital image.

7. The computer-implemented method of claim 1, wherein:
extracting the first set of visual features comprises utilizing a low-resolution vision encoder to extract low-resolution visual features;
extracting the second set of visual features comprises utilizing a high-resolution vision encoder to extract high-resolution visual features at a resolution higher than the low-resolution visual features; and
generating the predicted text phrase from the low-resolution visual features and the high-resolution visual features.

8. A system comprising:
one or more memory devices housing a vision-language model comprising a high-resolution vision encoder, a low-resolution vision encoder, a language decoder, and a cross-attention layer; and
one or more processors coupled to the one or more memory devices, the one or more processors configured to cause the system to:
extract, from a digital image utilizing the low-resolution vision encoder of the vision-language model, low-resolution visual features compatible with the language decoder;
extract high-resolution visual features from the digital image utilizing the high-resolution vision encoder of the vision-language model;
transform, utilizing the cross-attention layer of the vision-language model, the high-resolution visual features into key-value pairs compatible with the language decoder; and
generate, from the low-resolution visual features and the key-value pairs, a text phrase from text-rich content depicted in the digital image.

9. The system of claim 8, wherein the one or more processors are further configured to cause the system to receive, from a client device, the digital image and a text phrase prompt comprising instructions for detecting text depicted in the digital image.

10. The system of claim 9, wherein the one or more processors are further configured to cause the system to extract text embeddings from the text phrase prompt utilizing the language decoder of the vision-language model.

11. The system of claim 10, wherein the one or more processors are further configured to cause the system to generate the text phrase from the text embeddings in addition to the low-resolution visual features and the high-resolution visual features.

12. The system of claim 8, wherein the one or more processors are further configured to cause the system to transform the low-resolution visual features into an embedding space of the language decoder utilizing a projection matrix of the vision-language model.

13. The system of claim 8, wherein the one or more processors are further configured to cause the system to provide the text phrase for display with the digital image on a client device.

14. A non-transitory computer readable medium storing executable instructions which, when executed by a processing device, cause the processing device to perform operations comprising:
generating a pretraining dataset by selecting, from among a plurality of digital images with at least a threshold probability of depicting text-rich content, a subset of digital images corresponding to a set of text-rich image classifications;
generating a predicted text phrase from a digital image within the pretraining dataset utilizing a vision-language model comprising a low-resolution vision encoder, a high-resolution vision decoder, a language decoder, and a projection matrix for projecting features from the low-resolution vision encoder into an embedding space of the language decoder;
comparing the predicted text phrase with a ground truth text phrase for the digital image; and
modifying parameters of the projection matrix within the vision-language model based on comparing the predicted text phrase with the ground truth text phrase.

15. The non-transitory computer readable medium of claim 14, wherein the operations further comprise:
generating a finetuning dataset by determining, for one or more digital images within the subset of digital images corresponding to the set of text-rich image classifications, text phrase prompts that instruct the vision-language model to generate text phrases from the one or more digital images; and
generating predicted text phrases from the one or more digital images and the text phrase prompts utilizing the vision-language model.

16. The non-transitory computer readable medium of claim 15, wherein the operations further comprise:
comparing the predicted text phrases with ground truth text phrases corresponding to the one or more digital images and the text phrase prompts; and
modifying the parameters of the projection matrix and parameters of the language decoder based on comparing the predicted text phrases with the ground truth text phrases.

17. The non-transitory computer readable medium of claim 15, wherein generating the finetuning dataset comprises:
generating a resized digital image from the digital image among the subset of digital images corresponding to the set of text-rich image classifications;
generating a ground truth text phrase by utilizing an optical character recognition model to process the resized digital image; and
determining, to accompany the digital image as input to the vision-language model, a text phrase prompt comprising instructions for generating, from the digital image and the text phrase prompt, a text phrase to compare with the ground truth text phrase.

18. The non-transitory computer readable medium of claim 17, wherein determining the text phrase prompt comprises randomly sampling the text phrase prompt from a set of text phrase prompt variations.

19. The non-transitory computer readable medium of claim 14, wherein generating the pretraining dataset comprises:
determining, utilizing an image text detection model, probabilities of digital images depicting text-rich content;
identifying, from the probabilities, the plurality of digital images with at least the threshold probability of depicting text-rich content;
clustering the plurality of digital images according to image classifications; and
selecting, from the plurality of digital images, the subset of digital images from clusters corresponding to text-rich image classifications.

20. The non-transitory computer readable medium of claim 14, wherein modifying the parameters of the projection matrix comprises freezing the language decoder to prevent modifying decoder parameters based on the predicted text phrase.
